(19) United States
(12) Patent Application Publication
(10) Pub. No.: US 2026/0336646 A1
(43) Pub. Date: Oct. 29, 2026

(54) METHOD AND SYSTEM FOR PREVENTING SUDDEN ACCELERATION OF VEHICLE

(71) Applicant: HL Klemove Corp., Incheon (KR)

(72) Inventor: Yoonsuk CHOI, Incheon (KR)

(73) Assignee: HL Klemove Corp., Incheon (KR)

(21) Appl. No.: 19/347,158

(22) Filed: Oct. 1, 2025

(30) Foreign Application Priority Data
Apr. 25, 2025 (KR) 10-2025-0054585

(51) Int. Cl. B60W 50/12; B60W 30/14; B60W 30/16; B60W 50/038

(52) U.S. Cl. CPC B60W 50/12; B60W 30/146; B60W 30/16; B60W 50/038; B60W 2420/403; B60W 2420/408; B60W 2520/10; B60W 2540/10; B60W 2540/12; B60W 2540/30; B60W 2554/4041; B60W 2710/18; B60W 2720/106; B60W 2754/30

(57) ABSTRACT

A method for preventing sudden acceleration of a vehicle according to an embodiment of the present disclosure comprises: recognizing an abnormal sudden acceleration situation of an ego vehicle; determining whether a pedal misoperation by a driver has occurred; in response to determining that the pedal misoperation has occurred, determining whether a front vehicle exists in front of the ego vehicle; and controlling cruise control of the ego vehicle based on whether the front vehicle exists.

### CROSS-REFERENCE TO RELATED APPLICATION

This application claims the benefit of and priority to Korean Patent Application No. 2025-0054585 filed on Apr. 25, 2025, the entire disclosures of which are incorporated herein by reference.

### TECHNICAL FIELD

The present disclosure relates to a method and system for preventing sudden acceleration of a vehicle. More specifically, the present disclosure relates to a method and system for preventing sudden acceleration of a vehicle that can prevent accidents by distinguishing whether an abnormal sudden acceleration of the vehicle occurs due to pedal misoperation or vehicle malfunction.

### BACKGROUND

In a vehicle, sudden acceleration often occurs due to a driver's pedal misoperation.

In the case of such pedal misoperation, the driver is flustered and unable to reduce the vehicle speed, leading to significant damage due to collision with pedestrians, other vehicles, road facilities, and the like.

Further, even when the vehicle suddenly accelerates (sudden unintended acceleration) due to vehicle malfunction, similar damage often occurs.

Meanwhile, when sudden acceleration occurs due to a driver's pedal misoperation or a vehicle malfunction, performing sudden stops by operating the brake or forcibly turning off the engine may cause further accidents.

Therefore, there is a need for a method and system for preventing sudden acceleration of a vehicle that can distinguish between pedal misoperation and a vehicle malfunction, and control the vehicle differently depending on the situation, thereby preventing the occurrence of accidents.

### SUMMARY

The present disclosure is to solve the problems of the prior art described above, and an object of the present disclosure is to provide a method and system for preventing sudden acceleration of a vehicle that distinguishes between sudden acceleration due to a driver's pedal misoperation and sudden acceleration due to a vehicle error (vehicle malfunction), and accordingly controls the vehicle differently.

Further, an object of the present disclosure is to provide a method and system for preventing sudden acceleration of a vehicle that controls the vehicle differently depending on the presence or absence of a front vehicle when a driver misoperates a pedal, and controls the vehicle based on whether the vehicle error is an electronic control error or a mechanical device error in the case of a vehicle error (vehicle malfunction).

However, the technical problems to be achieved by the embodiments of the present disclosure are not limited to the technical problems described above, and other technical problems may exist.

As a technical means for achieving the above technical problem, a method for preventing sudden acceleration of a vehicle according to an embodiment of the present disclosure comprises: recognizing an abnormal sudden acceleration situation of an ego vehicle; determining whether a pedal misoperation by a driver has occurred; in response to determining that the pedal misoperation has occurred, determining whether a front vehicle exists in front of the ego vehicle; and controlling cruise control of the ego vehicle based on whether the front vehicle exists.

Further, in response to determining that the front vehicle exists, the controlling of cruise control of the ego vehicle may comprise controlling activating a first cruise control mode with limited acceleration.

Further, the first cruise control mode may be a cruise control mode which is activated at a current driving speed of the ego vehicle and maintains a predetermined inter-vehicle distance from the front vehicle, and suppresses acceleration override of the ego vehicle above a predetermined cruise control driving speed.

Further, in response to determining that a front vehicle does not exist, the controlling of cruise control of the ego vehicle may comprise activating a second cruise control mode with limited acceleration.

Further, when a current driving speed of the ego vehicle is less than a predetermined minimum speed, the second cruise control mode may be activated after accelerating the ego vehicle to be equal to or greater than the predetermined minimum speed, and acceleration override of the ego vehicle is suppressed above a predetermined cruise control driving speed.

The method may further comprise: determining whether the driver has performed a brake pedal override; and in response to the driver performing a brake pedal override, deactivating the first cruise control mode or the second cruise control mode.

The method may further comprise: in response to the driver not performing a brake pedal override, determining whether the first cruise control mode or the second cruise control mode is similar to a driving style of the driver; and in response to determining that a driving style according to the first cruise control mode or the second cruise control mode is similar to a usual driving style of the driver, switching to a normal cruise control mode in which an acceleration override is not limited.

Further, the determining of whether the pedal misoperation has occurred may comprise: collecting accelerator pedal sensor information and brake pedal sensor information; comparing an accelerator pedal effort by the driver with a predetermined maximum accelerator pedal effort threshold; and comparing a brake pedal effort by the driver with a predetermined minimum brake pedal effort threshold.

Further, in the determining of whether the pedal misoperation has occurred, it may be determined that the pedal misoperation has occurred in response to the accelerator pedal effort being greater than the predetermined maximum accelerator pedal effort threshold and the brake pedal effort being less than the predetermined minimum brake pedal effort threshold.

The method may further comprise: in response to determining that the pedal misoperation has not occurred, determining whether an accelerator pedal effort by the driver does not match with an output control signal; and in response to the accelerator pedal effort by the driver not matching with the output control signal, determining as an abnormal sudden acceleration situation due to an electronic control error.

The method may further comprise: in response to determining as the abnormal sudden acceleration situation due to the electronic control error, generating an output control signal from a separate signal controller; and operating an Electronic Parking Brake (EPB) such that a speed of the ego vehicle becomes 0.

The method may further comprise: in response to the accelerator pedal effort by the driver matching with the output control signal, determining as an abnormal sudden acceleration situation due to a mechanical device error; and operating an Electronic Parking Brake (EPB) such that a speed of the ego vehicle becomes 0.

A system for preventing sudden acceleration of a vehicle according to embodiments of the present disclosure comprises: a first sensor configured to detect surroundings of an ego vehicle; a second sensor comprising an accelerator pedal sensor configured to detect an accelerator pedal signal of the ego vehicle and a brake pedal sensor configured to detect a brake pedal signal; and a controller configured to control the ego vehicle to prevent sudden acceleration of the ego vehicle, wherein the controller is configured to determine whether a pedal misoperation by a driver has occurred from detected information of the first sensor and the second sensor, determine whether a front vehicle exists in response to determining that the pedal misoperation has occurred, and control cruise control of the ego vehicle based on whether the front vehicle exists.

Further, the first sensor may comprise at least one of a front camera and a front radar.

Further, the controller may be configured to, in response to determining that the front vehicle exists after determining that the pedal misoperation has occurred, activate a first cruise control mode with limited acceleration, and in response to determining that the front vehicle does not exists, activate a second cruise control mode with limited acceleration.

Further, the controller may be configured to, in response to the driver performing a brake pedal override, deactivate the first cruise control mode or the second cruise control mode.

Further, the controller may be configured to, in response to the driver not performing a brake pedal override and in response to determining that a driving style according to the first cruise control mode or the second cruise control mode is similar to a usual driving style of the driver, switch to a normal cruise control mode in which an acceleration override is not limited.

Further, the controller may be configured to, in response to determining that the pedal misoperation has not occurred and in response to accelerator pedal effort by the driver not matching with an output control signal, determine as an abnormal sudden acceleration situation due to an electronic control error, control a separate signal controller to generate an output control signal, and control a braking apparatus to operate an Electronic Parking Brake (EPB) such that a speed of the ego vehicle becomes 0.

Further, the controller may be configured to, in response to determining that the pedal misoperation has not occurred and in response to accelerator pedal effort by the driver matching with an output control signal, determine as an abnormal sudden acceleration situation due to a mechanical device error, and control a braking apparatus to operate an Electronic Parking Brake (EPB) such that a speed of the ego vehicle becomes 0.

Meanwhile, in a non-transitory computer-readable recording medium that records a program for executing a method for preventing sudden acceleration of a vehicle according to an embodiment of the present disclosure, the method comprises: recognizing an abnormal sudden acceleration situation of an ego vehicle; determining whether a pedal misoperation by a driver has occurred; in response to determining that the pedal misoperation has occurred, determining whether a front vehicle exists in front of the ego vehicle; and controlling cruise control of the ego vehicle based on whether the front vehicle exists.

The above-described means for solving the problem is only exemplary and should not be construed as limiting the present disclosure. In addition to the exemplary embodiments described above, additional embodiments may exist in the drawings and the following detailed description.

According to the problem-solving means of the present disclosure described above, it is possible to provide a method and system for preventing sudden acceleration of a vehicle that can prevent accidents of the ego vehicle by performing cruise control when a driver misoperates a pedal.

Further, according to the present disclosure, it is possible to distinguish between a driver's pedal misoperation and a vehicle error, and accordingly, when a sudden acceleration situation occurs due to a driver's pedal misoperation or a vehicle error, it is possible to provide a method and system for preventing sudden acceleration of a vehicle that can prevent secondary accidents due to sudden stops or the like.

However, the effects obtainable from the present disclosure are not limited to the effects described above, and other effects may exist.

### BRIEF DESCRIPTION OF THE DRAWINGS

FIG. 1 is a control flowchart showing a method for preventing sudden acceleration of a vehicle according to an embodiment of the present disclosure.

FIG. 2 is a control flowchart showing in more detail a step of recognizing an abnormal sudden acceleration situation and a step of determining a pedal misoperation in the method for preventing sudden acceleration of a vehicle according to the embodiment of the present disclosure.

FIG. 3 is a control flowchart showing a method for preventing sudden acceleration of a vehicle upon determining as an electronic control error or a mechanical device error in case that a pedal misoperation has not occurred, according to an embodiment of the present disclosure.

FIGS. 4A and 4B are diagrams for explaining driving scenarios according to the presence or absence of a front vehicle when determining pedal misoperation in the method for preventing sudden acceleration of a vehicle according to the embodiment of the present disclosure, and FIGS. 4C and 4D are diagrams for explaining driving scenarios according to an electronic control error or a mechanical device error in the method for preventing sudden acceleration of a vehicle according to the embodiment of the present disclosure.

FIG. 5 is a schematic control configuration diagram showing configuration of a system for preventing sudden acceleration of a vehicle according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a method and system for preventing sudden acceleration of a vehicle that distinguishes whether an abnormal sudden acceleration occurs due to a driver's pedal misoperation (mismanipulation) or a vehicle's electronic control error or mechanical device error, and to controls the vehicle to prevent accidents.

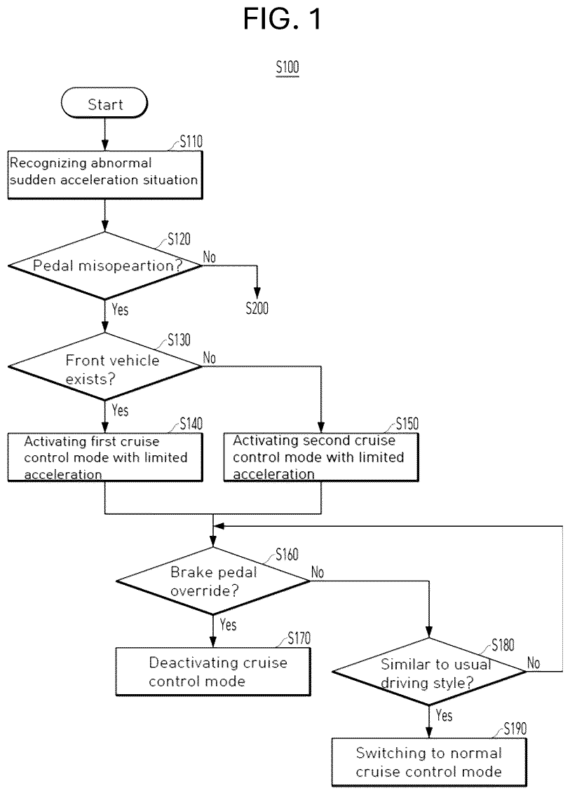

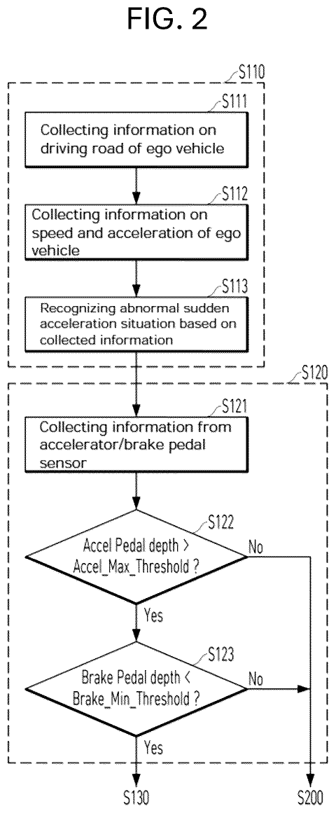

FIG. 1 is a control flowchart showing a method for preventing sudden acceleration of a vehicle according to an embodiment of the present disclosure. In addition, FIG. 2 is a control flowchart showing in more detail a step of recognizing an abnormal sudden acceleration situation and a step of determining a pedal misoperation in the method for preventing sudden acceleration of a vehicle according to the embodiment of the present disclosure.

Referring to FIG. 1, a method for preventing sudden acceleration of a vehicle S100 according to an embodiment of the present disclosure may comprise a step of recognizing an abnormal sudden acceleration situation of an ego vehicle S110. In the abnormal sudden acceleration situation recognizing step S110, an abnormal sudden acceleration situation may be recognized by detecting abnormal sudden acceleration of the ego vehicle in a situation where the ego vehicle should not suddenly accelerate.

Next, a pedal misoperation determining step of determining whether a pedal misoperation by a driver has occurred S120.

The reason for performing the pedal misoperation determining step S120 is to determine whether such abnormal sudden acceleration is due to the driver's pedal misoperation, in case that an abnormal sudden acceleration situation of the ego vehicle is recognized.

Hereinafter, the abnormal sudden acceleration situation recognizing step S110 and the pedal misoperation determining step 120 will be examined in more detail with reference to FIG. 2.

Referring to FIG. 2, the abnormal sudden acceleration situation recognizing step S110 may comprise collecting information on the driving road of the ego vehicle S111, collecting information on the speed and acceleration of the ego vehicle S112, and recognizing an abnormal sudden acceleration situation based on the collected information S113.

Specifically, the information regarding the driving road of the ego vehicle collected in step S111 may include the presence (existence) or absence (non-existence) of a front vehicle, vehicle speed limit information, and the like. In step S112, information on the speed and acceleration of the ego vehicle may be collected, and based on the information regarding the driving road and the information on the speed/acceleration of the ego vehicle collected in this way (considering collision-possible situations through such as TTC determination), it may be determined whether a sudden acceleration has occurred in a situation where the vehicle should not suddenly accelerate, or where the vehicle should decelerate (S113). Accordingly, an abnormal sudden acceleration situation of the ego vehicle may be recognized.

After recognizing the abnormal sudden acceleration situation of the ego vehicle, the pedal misoperation determining step S120 may be performed. The pedal misoperation determining step S120 may comprise collecting information from the accelerator pedal sensor and brake pedal sensor S121, comparing an accelerator pedal effort (Accel Pedal depth) of the driver with a predetermined maximum accelerator pedal effort threshold (Accel_Max_Threshold) S122, and comparing a brake pedal effort (Brake Pedal depth) with a predetermined minimum brake pedal effort threshold (Brake_Min_Threshold) S123.

Specifically, the step of collecting information from the accelerator pedal and the brake pedal S121 may be for detecting the accelerator pedal effort and the brake pedal effort performed by the driver.

Furthermore, determining whether the accelerator pedal effort by the driver is greater than a predetermined maximum accelerator pedal effort threshold may be performed in order to confirm whether the driver has pressed the accelerator pedal to the extent that the sudden acceleration occurs. Here, the predetermined maximum accelerator pedal effort threshold may be a preset value to an extent that can cause the sudden acceleration. That is, if an accelerator pedal effort greater than the predetermined maximum accelerator pedal effort threshold is detected, it may be determined that the abnormal sudden acceleration has occurred due to the driver pressing the accelerator pedal.

Meanwhile, determining whether the brake pedal effort by the driver is less than a predetermined minimum brake pedal effort threshold may be performed in order to confirm that the driver has not pressed the brake pedal. Here, the brake pedal effort less than a predetermined minimum brake pedal effort threshold may be a value to an extent that it may be determined that the driver has no intention to press the brake pedal. That is, if a brake pedal effort equal to or greater than the predetermined minimum brake pedal effort threshold is not detected, it may be confirmed that the driver has not pressed the brake pedal.

Accordingly, if the accelerator pedal effort (Accel Pedal depth) is greater than the predetermined maximum accelerator pedal effort threshold (Accel_Max_Threshold) (‘Yes’ in S122), and the brake pedal effort (Brake Pedal depth) is less than the predetermined minimum brake pedal effort threshold (Brake_Min_Threshold) (‘Yes’ in S123), it may be determined that the driver has misoperated the pedal (‘Yes’ in S120).

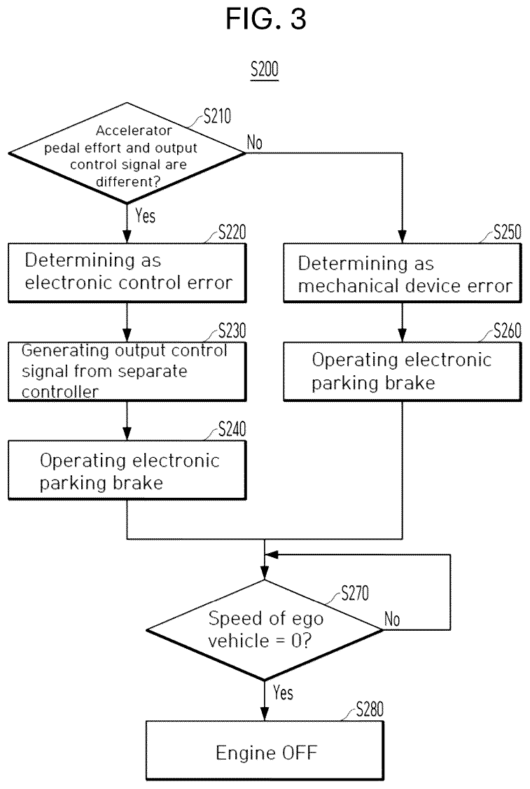

Referring back to FIG. 1, if it is determined that the driver has misoperated the pedal in the pedal misoperation determining step S120 (‘Yes’ in S120), it may be determined whether a front vehicle exists in front of the ego vehicle S130. Meanwhile, if it is determined that the abnormal sudden acceleration is not due to the pedal misoperation by the driver (‘No’ in S120), the process may proceed to step S200 described in FIG. 3, and it may be determined whether the abnormal sudden acceleration has occurred due to another reason.

Meanwhile, in the case where it is determined that the driver has misoperated the pedal, the cruise control mode of the ego vehicle may be controlled to be activated for accident prevention (without the driver's operation of the cruise control), and in this case, the cruise control of the ego vehicle may be controlled differently depending upon the presence or absence of a front vehicle.

Specifically, if a front vehicle of the ego vehicle exists in step S130 (‘Yes’ in S130), activating a first cruise control mode with limited acceleration S140 may be performed. In addition, if a front vehicle of the ego vehicle does not exist in S130 ('No′ in S130), activating a second cruise control mode with limited acceleration S150 may be performed.

Here, the first cruise control mode with limited acceleration may be a mode that activates a cruise control mode at a current driving speed of the ego vehicle, performs cruise control to maintain a predetermined inter-vehicle distance from the front vehicle, and suppresses acceleration override of the ego vehicle above a predetermined cruise control driving speed.

Specifically, according to the first cruise control mode, the ego vehicle may enter the cruise control mode while maintaining the current driving speed, and then the speed of the ego vehicle may be controlled to maintain a predetermined distance from the vehicle in front. For example, if the ego vehicle is driving at 20 kph (kilometers per hour), even if a minimum control speed at which the cruise control mode is activated is 30 kph, the ego vehicle may activate the cruise control mode at the current driving speed in order to prevent the risk of collision due to acceleration, if there exists a front vehicle.

In addition, in the first cruise control mode, even if the driver steps on the accelerator pedal to drive at a speed higher than the predetermined cruise control driving speed, the acceleration override may be suppressed such that driving speed does not exceed the predetermined cruise control driving speed. Here, the predetermined cruise control driving speed may be a value that can be changed based on the setting.

In addition, the second cruise control mode with limited acceleration may be a mode that activates a cruise control mode after accelerating to a predetermined minimum speed or higher when the current driving speed of the ego vehicle is lower than the predetermined minimum speed, and suppresses acceleration override of the ego vehicle above the predetermined cruise control driving speed.

Specifically, in the second cruise control mode with limited acceleration, if the ego vehicle is driving at a low speed (e.g., 20 kph) because there is no vehicle ahead, the ego vehicle may be controlled to drive more efficiently by accelerating to a predetermined minimum speed (minimum control speed of the cruise control mode, e.g., 30 kph) or higher and then entering (activating) the cruise control mode. In addition, as in the first cruise control mode, in the second cruise control mode as well, even if the driver steps on the accelerator pedal to drive at a speed higher than the predetermined cruise control driving speed, acceleration override is suppressed so that the driving speed of the ego vehicle does not exceed the predetermined driving speed.

Meanwhile, when activating the first cruise control mode or the second cruise control mode, the driver may be notified (e.g., by displaying a pop-up on the cluster) that the cruise control has been executed due to a pedal misoperation and the emergency lights of the ego vehicle may be turned on. In addition, along with the operation (activation) of the first cruise control mode or the second cruise control mode, the fact that the pedal misoperation has occurred may be recorded in the vehicle's recording device (e.g., a fault diagnosis device, etc.). Additionally, the driver may be informed that it is necessary to operate the brake to deactivate the first cruise control mode or the second cruise control mode.

In addition, when activating the first cruise control mode is in operation and the second cruise control mode, only the deactivation of the cruise control mode by brake override (deactivation by operating the brake) is possible, and acceleration override of the ego vehicle above the predetermined cruise control driving speed due to acceleration of the ego vehicle may be suppressed. This is to effectively prevent the risk of an accident (collision) caused by acceleration of the ego vehicle due to pedal misoperation.

Meanwhile, when activating the first cruise control mode or the second cruise control mode, the cruise control mode may be deactivated by the driver's brake pedal override (S170). Specifically, when the driver presses the brake pedal with a predetermined pressure or more (brake pedal override), the cruise control mode may be released (deactivated). At this time, a display indicating that the cruise control mode has been deactivated due to the brake pedal operation may be displayed on the cluster of the ego vehicle (for example, a pop-up display on the cluster).

Meanwhile, if the driver does not perform a brake pedal override and the cruise control mode is not deactivated, it is possible to determine whether the driving style according to the cruise control mode is similar to the driver's usual driving style during operation of the first cruise control mode or the second cruise control mode (S180).

The determination of similarity may be performed by storing the driver's usual driving distance, acceleration strength (acceleration tendency), driver's reaction speed, etc. in memory and comparing the driving style of the first cruise control mode or the second cruise control mode with the stored driving style of the driver to determine whether it substantially matches.

If the driving style according to the cruise control mode is determined to be similar to the driver's usual driving style (‘Yes’ in S180), it may be switched to the normal cruise control mode (S190). This is because if the driving style of the cruise control mode in operation is determined to be substantially not different from the driver's usual driving style, the risk of an accident is low, so it is determined that there is no problem with driving safety even if the ego vehicle drives in the normal cruise control mode including the acceleration override function.

Here, the normal cruise control mode may refer to a mode in which all functions of the cruise control mode are activated, and for example, according to the normal cruise control mode, the acceleration override (for example, acceleration above a predetermined driving speed due to the driver's operation of the accelerator pedal) may not be suppressed. Even when switching to normal cruise control mode, a notification may appear on your vehicle's cluster indicating that it is switched to the normal cruise control mode due to driving style linkage (e.g., a pop-up display on the cluster).

According to the above-described embodiment of the present disclosure, in the case where sudden acceleration occurred due to the driver's pedal misoperation, it is possible to prevent an accident due to a frontal collision more effectively by operating the cruise control mode of the ego vehicle but controlling the cruise control mode differently depending upon the presence of the front vehicle.

FIG. 3 is a control flowchart showing a method for preventing sudden acceleration of a vehicle upon determining as an electronic control error or a mechanical device error in case that a pedal misoperation has not occurred, according to an embodiment of the present disclosure.

Referring to FIG. 3, if it is determined in the abnormal sudden acceleration determination step that the sudden acceleration of the ego vehicle is not due to pedal misoperation (‘No’ in S120), determining whether the accelerator pedal effort and the output control signal are different (not matching) S210 may be performed. For example, in step S210, it may be determined whether the accelerator pedal effort by the driver matches with the throttle signal or electric signal (in the case of an electric vehicle) from an ECU (Electronic Control Unit) or a DCU (Domain Control Unit).

If it is determined in step S210 that the accelerator pedal effort does not match with the output control signal (‘Yes’ in S210), it may be determined that the sudden acceleration of the ego vehicle is due to an electronic control error (S220).

If it is determined as an electronic control error, since it is determined that a problem has occurred in the controller (ECU or DCU), an output control signal may be generated from a separate signal controller (a controller which is different from the ECU or DCU) (S230). Here, the output control signal from the separate signal controller may have priority over the output control signal from the controller (ECU or DCU). In addition, the electronic parking brake (EPB) of the ego vehicle may be operated (S240), thereby reducing the speed of the ego vehicle with turning on the emergency lights of the ego vehicle.

If it is determined in step S210 that the accelerator pedal effort and the output control signal are matching (‘No’ in S210), it may be determined that there is no problem with the electronic control device, and therefore it may be determined that the abnormal sudden acceleration has been caused by an error in the mechanical device (S250).

If sudden acceleration occurs due to the mechanical device error, there is no problem with the output control signal, so the electronic parking brake (EPB) may be immediately operated (S260), reducing the speed of the vehicle with turning on the emergency lights of the ego vehicle.

The purpose of automatically operating the electronic parking brake as described above is to reduce the speed of the suddenly accelerating vehicle. In the case of a mechanical parking brake, there is a possibility of the vehicle spinning when the parking brake is operated at high speeds, but in the case of the electronic parking brake (EPB), since it operates in conjunction with the ABS (Anti-lock Braking System), problems such as spinning do not occur even when the brake being operated at high speeds. Therefore, the electronic parking brake may be engaged (operated) in the embodiments of the present disclosure.

After the electronic parking brake is operated (S240, S260), it is determined whether the speed of the ego vehicle is 0 (S270), and if the speed of the ego vehicle is 0 (the ego vehicle has stopped) (‘Yes’ of S270), the engine of the own vehicle may be controlled to be turned OFF (S280).

This is to further improve the safety of the driver of the ego vehicle by turning off the engine after the vehicle has come to a complete stop, because turning off the engine while the vehicle is in motion makes steering the vehicle difficult.

Meanwhile, along with the electronic parking brake, steering control may be additionally performed to position the ego vehicle on the shoulder of the road by controlling the steering wheel of the ego vehicle, if necessary. Accordingly, secondary accidents such as rear-end collisions can be prevented by allowing the ego vehicle to stop in a safer location.

According to the embodiments of the present disclosure, in the case of abnormal sudden acceleration due to vehicle error rather than the driver's pedal misoperation, it is possible to distinguish whether the abnormal sudden acceleration is due to an electronic control error or a mechanical device error, and accordingly, the speed of the vehicle can be stably reduced and the vehicle can be stopped, thereby preventing an accident and improving driver safety.

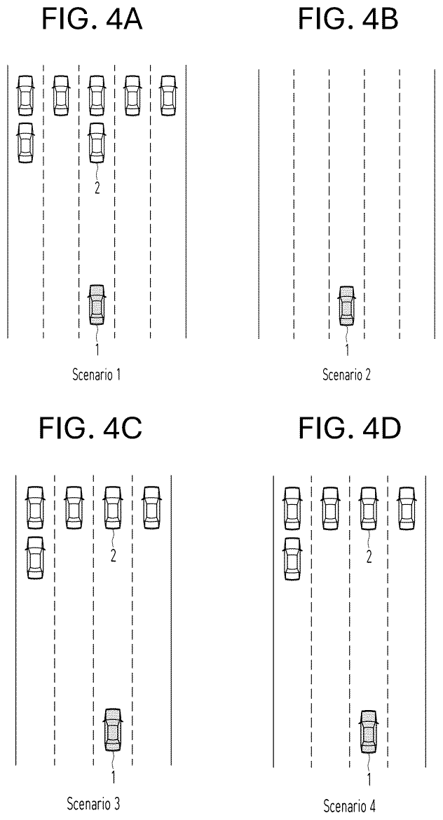

FIGS. 4A and 4B are diagrams for explaining driving scenarios according to the presence or absence of a front vehicle when determining pedal misoperation in the method for preventing sudden acceleration of a vehicle according to the embodiment of the present disclosure, and FIGS. 4C and 4D are diagrams for explaining driving scenarios according to an electronic control error or a mechanical device error in the method for preventing sudden acceleration of a vehicle according to the embodiment of the present disclosure.

FIG. 4A is a diagram showing a case where a front vehicle 2 exists in front of the ego vehicle 1 in a case where the ego vehicle 1 is abnormally suddenly accelerated due to a driver's pedal misoperation (Scenario 1), and FIG. 4B is a diagram showing a case where a front vehicle does not exist in front of the ego vehicle 1 in a case where the ego vehicle 1 is abnormally suddenly accelerated due to a driver's pedal misoperation (Scenario 2).

In these cases, if an abnormal sudden acceleration situation of the ego vehicle is recognized and after determining whether a predetermined condition is satisfied, if it is determined that the sudden acceleration is due to a pedal misoperation by the driver of the ego vehicle 1, cruise control mode may be activated to control the ego vehicle 1, and the cruise control mode may be controlled differently between when a front vehicle 2 exists (FIG. 4A) and when a front vehicle 2 does not exist (FIG. 4B). Since the specific cruise controls have been described in the description of FIG. 1, a specific description thereof will be omitted here.

FIG. 4C is a diagram showing a case where the ego vehicle 1 is abnormally suddenly accelerated due to an electronic control error (Scenario 3), and FIG. 4D is a diagram showing a case where the ego vehicle 1 is abnormally suddenly accelerated due to a mechanical device error (Scenario 4).

In the case where the ego vehicle 1 suddenly accelerates due to an electronic control error (FIG. 4C), a separate signal controller may be configured to generate an output control signal that has priority over the ECU or DCU, and output control signal “0” may be sent out and the electronic parking brake (EPB) may be automatically operated to reduce the driving speed of the ego vehicle 1. In addition, in the case where sudden acceleration is performed due to the mechanical device error (FIG. 4D), the driving speed of the ego vehicle 1 may be reduced by immediately operating the electronic parking brake. In both cases, the engine of the ego vehicle 1 may be controlled to be turned OFF after the driving speed of the vehicle becomes 0.

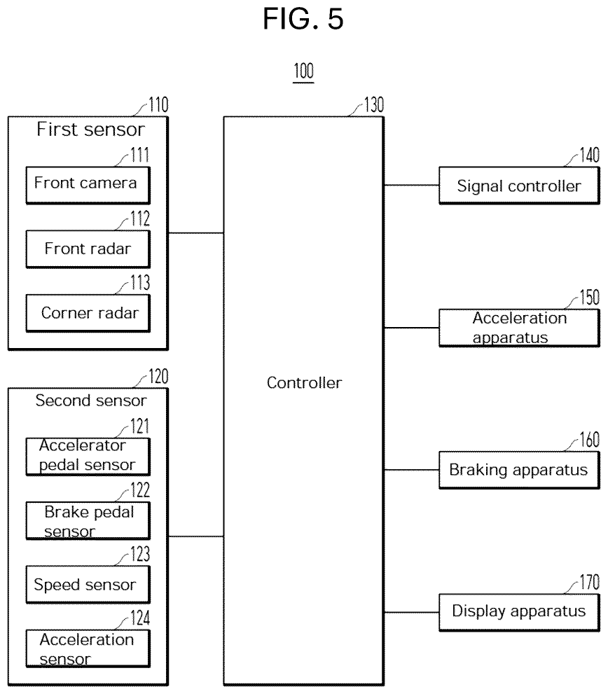

FIG. 5 is a schematic control configuration diagram showing configuration of a system for preventing sudden acceleration of a vehicle according to embodiments of the present disclosure.

Referring to FIG. 5, a system for preventing sudden acceleration of a vehicle 100 according to embodiments of the present disclosure may comprise a first sensor 110 configured to detect surroundings of an ego vehicle; a second sensor 120 comprising an accelerator pedal sensor 121 configured to detect an accelerator pedal signal of the ego vehicle and a brake pedal sensor 122 configured to detect a brake pedal signal; and a controller 130 configured to control the ego vehicle to prevent sudden acceleration of the ego vehicle.

The controller 130 may be configured to determine whether a pedal misoperation by a driver has occurred from detected information of the first sensor 110 and the second sensor 120, and in response to determining that the driver has misoperated a pedal, determine whether a front vehicle exists, and control cruise control of the ego vehicle based on whether the front vehicle exists.

The first sensor 110 may include at least one of a front camera 111 and a front radar 112. In addition, the first sensor 110 may further include at least one corner radar 113. However, the sensors included in the first sensor 110 are not limited thereto, and the first sensor 110 may further include other types of sensors for sensing the surroundings of the vehicle, such as a lidar sensor, an ultrasonic sensor, and the like.

A front vehicle may be detected by a sensor provided in the first sensor 110, and the speed of the front vehicle may be detected to determine the risk of collision. In addition, vehicle speed limit information may be detected by a sensor provided in the first sensor 110. Meanwhile, the collection of vehicle speed limit information may also be performed through navigation information or the like.

The second sensor 120 may include an accelerator pedal sensor 121 and a brake pedal sensor 122. By the accelerator pedal sensor 121 and the brake pedal sensor 122, information regarding the driver's accelerator pedal effort and brake pedal effort may be collected, and accordingly, it may be determined whether the driver has misoperated a pedal, whether brake pedal override has occurred, and the like.

In addition, the second sensor 120 may also include a speed sensor 123 configured to detect the speed of the ego vehicle and an acceleration sensor 124 configured to detect the acceleration of the ego vehicle. By the speed sensor 123 and the acceleration sensor 124, information regarding the speed and acceleration of the ego vehicle may be collected, and based on the information, it may be determined whether sudden acceleration of the ego vehicle has occurred.

Meanwhile, the sensors included in the second sensor 120 are not limited to the above, and if it is a sensor for sensing body information of the ego vehicle, other types of sensors such as a steering angle sensor, a turn signal sensor, and the like may be further included.

If it is determined that a front vehicle exists after determining that the pedal misoperation has occurred, the controller 130 may activate a first cruise control mode with limited acceleration, and in response to determining that the front vehicle does not exists, activate a second cruise control mode with limited acceleration.

In addition, in response to the driver performing a brake pedal override, the controller 130 may deactivate the first cruise control mode or the second cruise control mode.

In addition, in response to the driver not performing a brake pedal override and in response to determining that a driving style according to the first cruise control mode or the second cruise control mode is similar to a usual driving style of the driver, the controller 130 may switch to a normal cruise control mode in which an acceleration override is not limited.

The controller 130 may be connected to a separate signal controller 140 configured to transmit an output control signal. For example, the output control signal may be a throttle signal, and in this case, the signal controller 140 may be a throttle controller. In addition, the controller 130 may be connected to an acceleration apparatus 150 configured to control acceleration of the ego vehicle and a braking apparatus 160 configured to control braking of the ego vehicle.

Accordingly, in response to determining that the pedal misoperation has not occurred and in response to accelerator pedal effort by the driver not matching with an output control signal, the controller 130 may determine as an abnormal sudden acceleration situation due to an electronic control error, control a separate signal controller 140 to generate an output control signal, and control a braking apparatus 160 to operate an Electronic Parking Brake (EPB) such that a speed of the ego vehicle becomes 0. In addition, along with the operation of the electronic parking brake, the hazard lights (emergency lights) of the ego vehicle may be turned on to provide a warning of a dangerous situation to following vehicles.

In addition, in response to determining that the pedal misoperation has not occurred and in response to accelerator pedal effort by the driver matching with an output control signal, the controller 130 may determine as an abnormal sudden acceleration situation due to a mechanical device error, and control a braking apparatus 160 to operate an Electronic Parking Brake (EPB) such that a speed of the ego vehicle becomes 0. In addition, along with the operation of the electronic parking brake, the hazard lights (emergency lights) of the ego vehicle may be turned on to provide a warning of a dangerous situation to following vehicles.

In addition, the controller 130 according to the embodiment of the present disclosure may control at least one of the acceleration apparatus 150 and the braking apparatus 160 to control the ego vehicle to drive according to the first cruise control mode, the second cruise control mode, or the normal cruise control mode, according to the embodiments of the present disclosure.

Further, the controller 130 may be connected to a display apparatus 170 configured to provide information to the driver of the ego vehicle. Here, the display apparatus may be a cluster (or HMI; Human Machine Interface), and for example, can provide notifications to the driver as needed in the form of a pop-up on the cluster.

Specifically, in the embodiment of the present disclosure, when entering (activating) the first cruise control mode or the second cruise control mode, the driver may be notified that the cruise control mode has been executed due to pedal misoperation, and the driver may be notified when the cruise control mode has been deactivated due to brake override or when switched to the normal cruise control mode due to driving style linkage.

Regarding the method for preventing sudden acceleration of a vehicle according to the embodiments of the present disclosure performed by the controller 130, since it has been described in detail previously, a detailed description thereof will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the embodiments of the present disclosure as described above, it is possible to provide a method and system for preventing sudden acceleration of a vehicle that can prevent accidents caused by a driver's pedal misoperation, and can also prevent secondary accidents due to sudden stops or engine OFF when sudden acceleration has occurred due to a driver's pedal misoperation or a device error.

Furthermore, according to the method and system for preventing sudden acceleration of a vehicle according to the embodiments of the present disclosure, in an abnormal sudden acceleration situation, the driver's pedal misoperation and the device error can be clearly distinguished, which can be helpful in diagnosing vehicle malfunctions and determining responsibility.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

1: Ego vehicle
2: Front vehicle
100: System for preventing sudden acceleration of vehicle
110: First sensor
111: Front camera
112: Front radar
113: Corner radar
120: Second sensor
121: Accelerator pedal sensor
122: Brake pedal sensor
123: Speed sensor
124: Acceleration sensor
130: Controller
140: Signal controller
150: Acceleration apparatus
160: Braking apparatus
170: Display apparatus

1. A method for preventing sudden acceleration of a vehicle, comprising:
recognizing an abnormal sudden acceleration situation of an ego vehicle;
determining whether a pedal misoperation by a driver has occurred;
in response to determining that the pedal misoperation has occurred, determining whether a front vehicle exists in front of the ego vehicle; and
controlling cruise control of the ego vehicle based on whether the front vehicle exists.

2. The method of claim 1, wherein in response to determining that the front vehicle exists, the controlling of cruise control of the ego vehicle comprises controlling activating a first cruise control mode with limited acceleration.

3. The method of claim 2, wherein the first cruise control mode is a cruise control mode which is activated at a current driving speed of the ego vehicle and maintains a predetermined inter-vehicle distance from the front vehicle, and suppresses acceleration override of the ego vehicle above a predetermined cruise control driving speed.

4. The method of claim 3, wherein in response to determining that a front vehicle does not exist, the controlling of cruise control of the ego vehicle comprises activating a second cruise control mode with limited acceleration.

5. The method of claim 4, wherein when a current driving speed of the ego vehicle is less than a predetermined minimum speed, the second cruise control mode is activated after accelerating the ego vehicle to be equal to or greater than the predetermined minimum speed, and acceleration override of the ego vehicle is suppressed above a predetermined cruise control driving speed.

6. The method of claim 5, further comprising:
determining whether the driver has performed a brake pedal override; and
in response to the driver performing a brake pedal override, deactivating the first cruise control mode or the second cruise control mode.

7. The method of claim 6, further comprising:
in response to the driver not performing a brake pedal override, determining whether the first cruise control mode or the second cruise control mode is similar to a driving style of the driver; and
in response to determining that a driving style according to the first cruise control mode or the second cruise control mode is similar to a usual driving style of the driver, switching to a normal cruise control mode in which an acceleration override is not limited.

8. The method of claim 1, wherein the determining of whether the pedal misoperation has occurred comprises: collecting accelerator pedal sensor information and brake pedal sensor information; comparing an accelerator pedal effort by the driver with a predetermined maximum accelerator pedal effort threshold; and comparing a brake pedal effort by the driver with a predetermined minimum brake pedal effort threshold.

9. The method of claim 8, wherein in the determining of whether the pedal misoperation has occurred, it is determined that the pedal misoperation has occurred in response to the accelerator pedal effort being greater than the predetermined maximum accelerator pedal effort threshold and the brake pedal effort being less than the predetermined minimum brake pedal effort threshold.

10. The method of claim 1, further comprising:
in response to determining that the pedal misoperation has not occurred, determining whether an accelerator pedal effort by the driver does not match with an output control signal; and
in response to the accelerator pedal effort by the driver not matching with the output control signal, determining as an abnormal sudden acceleration situation due to an electronic control error.

11. The method of claim 10, further comprising:
in response to determining as the abnormal sudden acceleration situation due to the electronic control error, generating an output control signal from a separate signal controller; and
operating an Electronic Parking Brake (EPB) such that a speed of the ego vehicle becomes 0.

12. The method of claim 10, further comprising:
in response to the accelerator pedal effort by the driver matching with the output control signal, determining as an abnormal sudden acceleration situation due to a mechanical device error; and
operating an Electronic Parking Brake (EPB) such that a speed of the ego vehicle becomes 0.

13. A system for preventing sudden acceleration of a vehicle, comprising:
a first sensor configured to detect surroundings of an ego vehicle;
a second sensor comprising an accelerator pedal sensor configured to detect an accelerator pedal signal of the ego vehicle and a brake pedal sensor configured to detect a brake pedal signal; and
a controller configured to control the ego vehicle to prevent sudden acceleration of the ego vehicle,
wherein the controller is configured to determine whether a pedal misoperation by a driver has occurred from detected information of the first sensor and the second sensor, determine whether a front vehicle exists in response to determining that the pedal misoperation has occurred, and control cruise control of the ego vehicle based on whether the front vehicle exists.

14. The system of claim 13, wherein the first sensor comprises at least one of a front camera and a front radar.

15. The system of claim 13, wherein the controller is configured to, in response to determining that the front vehicle exists after determining that the pedal misoperation has occurred, activate a first cruise control mode with limited acceleration, and in response to determining that the front vehicle does not exists, activate a second cruise control mode with limited acceleration.

16. The system of claim 15, wherein the controller is configured to, in response to the driver performing a brake pedal override, deactivate the first cruise control mode or the second cruise control mode.

17. The system of claim 15, wherein the controller is configured to, in response to the driver not performing a brake pedal override and in response to determining that a driving style according to the first cruise control mode or the second cruise control mode is similar to a usual driving style of the driver, switch to a normal cruise control mode in which an acceleration override is not limited.

18. The system of claim 13, wherein the controller is configured to, in response to determining that the pedal misoperation has not occurred and in response to accelerator pedal effort by the driver not matching with an output control signal, determine as an abnormal sudden acceleration situation due to an electronic control error, control a separate signal controller to generate an output control signal, and control a braking apparatus to operate an Electronic Parking Brake (EPB) such that a speed of the ego vehicle becomes 0.

19. The system of claim 13, wherein the controller is configured to, in response to determining that the pedal misoperation has not occurred and in response to accelerator pedal effort by the driver matching with an output control signal, determine as an abnormal sudden acceleration situation due to a mechanical device error, and control a braking apparatus to operate an Electronic Parking Brake (EPB) such that a speed of the ego vehicle becomes 0.

20. A non-transitory computer-readable recording medium that records a program for executing a method for preventing sudden acceleration of a vehicle on a computer, the method comprising:
recognizing an abnormal sudden acceleration situation of an ego vehicle;
determining whether a pedal misoperation by a driver has occurred;
in response to determining that the pedal misoperation has occurred, determining whether a front vehicle exists in front of the ego vehicle; and
controlling cruise control of the ego vehicle based on whether the front vehicle exists.
